(19) United States
(12) Patent Application Publication
(10) Pub. No.: US 2005/0009392 A1
(43) Pub. Date: Jan. 13, 2005

(54) Terminal insertion improvements for memory card connectors

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 10/869,610

(22) Filed: Jun. 17, 2004

(30) Foreign Application Priority Data
Jun. 17, 2003 (TW) 92211037

(51) Int. Cl. H01R 29/00

(52) U.S. Cl. 439/188

(57) ABSTRACT

A memory card connector includes an insulative housing having a rear terminal-mounting section and at least one side wall section extending forwardly from one end of the rear section defining a card-receiving space therewith. The housing has at least a pair of switch terminal mounting slots in a surface of the housing. A recessed platform is formed in the surface adjacent each mounting slot. At least a pair of switch terminals are insertable into the mounting slots. Therefore, an appropriate insertion fixture can be provided with wide terminal-engagement blocks aligned with the recessed platforms to fully insert the switch terminals into the mounting slots.

### FIELD OF THE INVENTION

This invention generally relates to the art of electrical connectors and, particularly, to a memory card connector having means for facilitating insertion of terminals, such as switch terminals, into slots in the connector housing.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like.

Some memory card connectors are provided with a write-protection function by means of a pair of elastic conductive terminals forming a controlling switch. The two switch terminals are mounted at a side of the connector and have respective elastic arms arranged in close proximity to each other and may be moved into mutual engagement by the memory card to close the controlling switch. Some memory card connectors also are provided with a detector function by means of a pair of elastic conductive terminals forming a detector switch. The detector switch typically is at a rear of the connector and is actuated by a leading edge of a memory card to “detect” that the card has been fully inserted into the connector. Some memory card connectors have both a write-protection function and a card detector function, with a common or “third” conductive terminal forming one of the switch terminals of both switches.

The switch terminals for effecting the various functions of the memory card, such as those described above, typically are stamped and formed of sheet metal material. The terminals include thin body portions which are fixed within very narrow slots in the connector housing. In fact, the thickness of the body portions is only the thickness of the sheet metal material. This makes it quite difficult for an insertion fixture of an assembly apparatus to engage the very thin terminals and fully insert the terminals into the very narrow mounting slots in the housing. Wide fixture portions will abut the mounting surface of the connector housing, and often the terminals may not be filly inserted into their respective slots. The present invention is directed to solving these problems.

### SUMMARY OF THE INVENTION

An object, therefore, of the invention is to provide means for facilitating the insertion of terminals, such as switch terminals, into mounting slots in connector housings, such as for memory card connectors.

In the exemplary embodiment of the invention, a memory card connector includes an insulative housing having a rear terminal-mounting section and at least one side wall section extending forwardly from one end of the rear section defining a card-receiving space therewith. The housing has at least a pair of switch terminal mounting slots in a surface of the housing. A recessed platform is formed in the surface adjacent each mounting slot. At least a pair of switch terminals are insertable into the mounting slots. Therefore, an appropriate insertion fixture can be provided with wide terminal-engagement blocks aligned with the recessed platforms to fully insert the switch terminals into the mounting slots.

According to one aspect of the invention, portions of the switch terminals adjacent the recessed platforms are relatively thin and are disposed in relatively narrow sections of the mounting slots. As disclosed herein, the switch terminals are stamped and formed of sheet metal material, and the portions of the terminals adjacent the recessed platforms are only as thick as the sheet metal material of the terminals.

According to another aspect of the invention, the mounting slots are in a top surface of the side wall section of the housing. A pair of the recessed platforms are formed in the surface on diametrically opposite sides of the mounting slots.

According to a further aspect of the invention, the switch terminals have body portions fixed in the mounting slots in the housing, contact spring arms cantilevered from the body portions and contact portions at free ends of the contact spring arms. The recessed platforms are located at sections of the mounting slots whereat the body portions are inserted.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connector incorporating the concepts of the invention, with the switch terminals lifted from the housing;

FIG. 2 is a view similar to that of FIG. 1, with the terminals mounted in the connector housing;

FIG. 3 is an enlarged, fragmented perspective view of an area encircled at “A” in FIG. 2;

FIG. 4 is a view similar to that of FIG. 3, but at a different angle; and

FIG. 5 is a top plan view of the connector.

### DETAILED DESCRIPTION OF THE PREFERRED EMBODIMENT

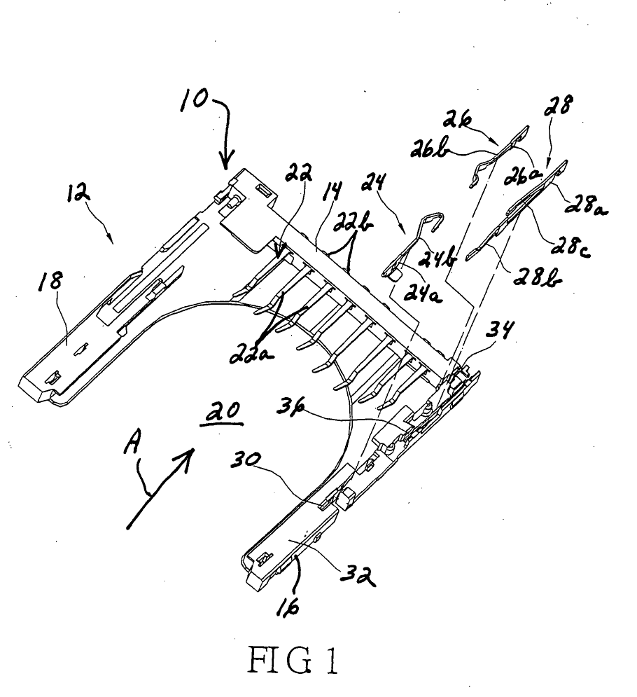

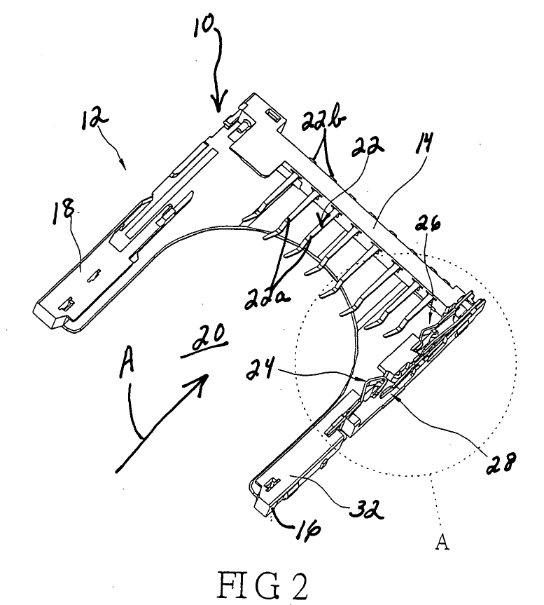

Referring to the drawings in greater detail, and first to FIGS. 1 and 2, the invention is embodied in a memory card connector, generally designated 10, which includes a dielectric or insulative housing, generally designated 12. The housing includes a rear terminal-mounting section 14 and a pair of side wall sections 16 and 18 extending forwardly from opposite one ends of the rear section and defining a card-receiving space 20 therewith. Therefore, the housing is generally U-shaped, as shown. However, some memory card connectors have L-shaped housings, with only one side wall section.

In either event, a plurality of conductive connector terminals, generally designated 22, are mounted in rear terminal-mounting section 14 of the housing. The terminals have elongated contact portions 22a projecting forwardly of rear section 14 into card-receiving space 20 for engaging appropriate contacts on a memory card inserted into the space in the direction of arrow “A”. The connector, including housing 12, is adapted for mounting on a printed circuit board, and terminals 22 have tail portions 22b for connection, as by soldering, to appropriate circuit traces on the printed circuit board.

A first switch terminal, generally designated 24; a second switch terminal, generally designated 26; and a third or “common” switch terminal, generally designated 28, all are mounted on side wall section 16 and the end of rear section 14 of the housing. As stated in the “Background”, above, some memory card connectors are provided with a write-protection function, and some memory card connectors are provided with a detector function. Connector 10 is provided with both functions and switch terminals 24, 26 and 28 effectively perform those functions. Accordingly, first switch terminal 24 can be considered the “write-protection” terminal, second switch terminal 26 can be considered the card detector terminal and third switch terminal 28 can is a common terminal operatively associated with both switch terminals 24 and 26.

All three switch terminals 24, 26 and 28 are stamped and formed of conductive sheet metal material. Therefore, it can be understood that the thickness of most of the components of the terminal is only as thick as the sheet metal material, itself. First switch terminal 24 has a body portion 24a; second switch terminal 26 has a body portion 26a; and third switch terminal 28 has a body portion 28a. A contact spring arm 24b is cantilevered from body portion 24a of first switch terminal 24; a contact spring arm 26b is cantilevered from body portion 26a of second switch terminal 26; and a pair of contact spring arms 28b and 28c are cantilevered from body portion 28a of common switch terminal 28. All of the contact spring arms have contact portions at the free end thereof, whereby the contact portion at the free end of contact spring arm 28b of the common terminal is engageable with the contact portion at the free end of contact spring arm 24b of first switch terminal 24. The contact portion at the free end of contact spring arm 28c of the common switch terminal is engageable with the contact portion at the free end of contact spring arm 26b of second switch terminal 26.

Body portion 24a of first switch terminal 24 is inserted into a mounting slot 30 in a top surface 32 of side wall section 16 of housing 12. Body portion 26a of second switch terminal 26 is inserted into a mounting slot 34. Body portion 28a of common switch terminal 28 is inserted into a mounting slot 36. It can be understood that with the body portions of the terminals being only as wide as the thickness of the sheet metal material from which the body portions are stamped and formed, slots 30, 34 and 36 are very narrow. It follows, then, that it is extremely difficult to provide an insertion fixture which engages the top edges of the thin body portions and fully insert the body portions (and terminals) into their respective mounting slots.

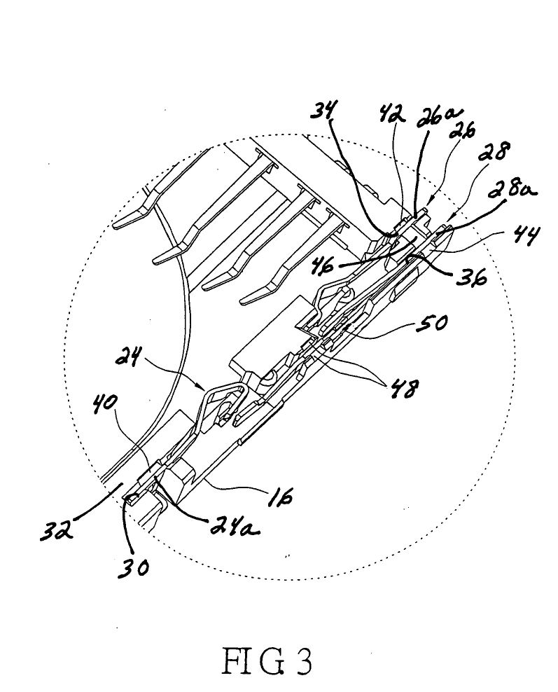

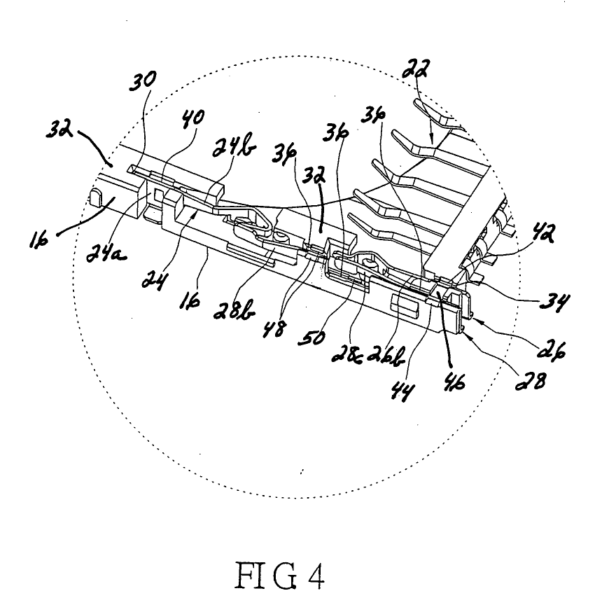

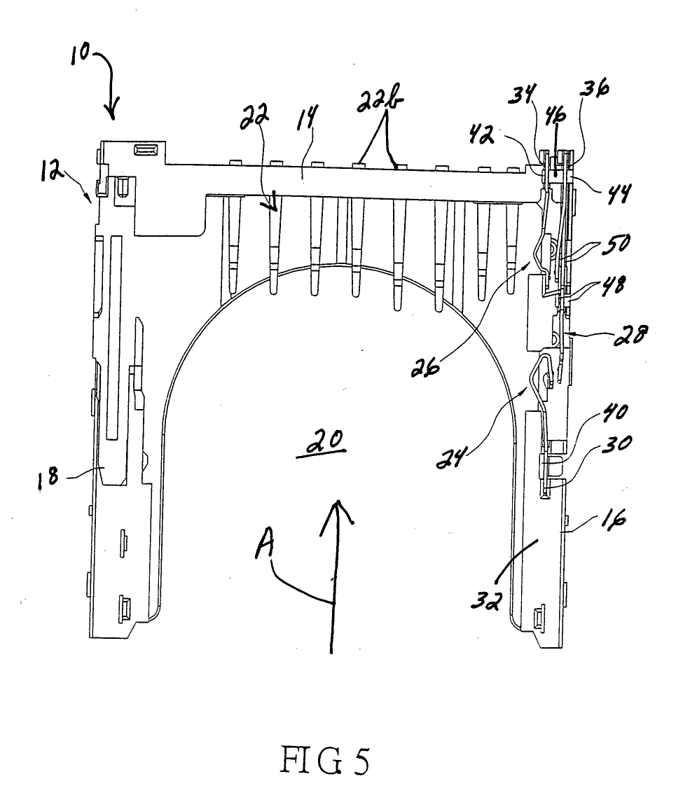

Generally, the invention contemplates providing means to solve the above-described insertion problems. Specifically, referring to FIGS. 3-5, a recessed platform 40 is formed in top surface 32 of side wall section 16 immediately adjacent mounting slot 30 within which body portion 24a of first switch terminal 24 is inserted. Similarly, a recessed platform 42 is provided immediately adjacent the inside of slot 34 into which body portion 26a of second switch terminal 26 is inserted. A recessed platform 44 is provided immediately adjacent the outside of mounting slot 36 into which body portion 28a of common terminal 28 is inserted. Recessed platforms 42 and 44 are across from each other transversely of slots 34 and 36, and a third recessed platform 46 is provided between the slots. Therefore, recessed platforms 42, 44 and 46 are effectively provided at diametrically opposite sides of the slots. Body portion 28a of the common terminal is elongated, and an additional pair of recessed platforms 48 are provided in top surface 32 of side wall section 16 at diametrically opposite sides of mounting slot 36. Finally, an auxiliary platform 50 is provided in the housing at a level below top surface 32 of side wall section 16. This auxiliary side wall section facilitates engagement with a lower section of body portion 28a of common switch terminal 28.

From the foregoing, it can be understood that recessed platforms 40, 42, 44, 46, 48 and 50 on the housing of connector 10 provide areas for wide terminal-engagement blocks of an appropriate insertion fixture to engage the thin body portions of the switch terminals to insert the body portions into narrow slots 30, 34 and 36. In essence, the recessed platforms form wide top sections of the narrow slots to accommodate the wider terminal-engagement blocks of the insertion fixture, while the remainder of the narrow mounting slots maintain the precise positioning of the switch terminals.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
an insulative housing having a rear terminal-mounting section and at least one side wall section extending forwardly from one end of the rear section defining a card-receiving space therewith, the housing having at least a pair of switch terminal mounting slots in a surface of the housing, and a recessed platform in said surface adjacent each mounting slot; and
at least a pair of switch terminals insertable into the mounting slots in the housing, whereby an appropriate insertion fixture can be provided with relatively wide terminal-engagement blocks aligned with said recessed platforms to fully insert the switch terminals into the mounting slots.

2. The memory card connector of claim 1 wherein portions of said switch terminals adjacent said recessed platforms are relatively thin and disposed in relatively narrow sections of the mounting slots.

3. The memory card connector of claim 2 wherein said switch terminals are stamped and formed of sheet metal material, and said portions of the terminals adjacent the recessed platforms are only as thick as the sheet metal material of the terminals.

4. The memory card connector of claim 1, including a pair of said recessed platforms in said surface on diametrically opposite sides of at least one mounting slot.

5. The memory card connector of claim 1 wherein said mounting slots are in a surface of the side wall section of the housing.

6. The memory card connector of claim 5 wherein said mounting slots are in a top surface of the side wall section of the housing.

7. The memory card connector of claim 1 wherein said switch terminals have body portions fixed in the mounting slots in the housing, contact spring arms cantilevered from the body portions and contact portions at free ends of the contact spring arms, said recessed platforms being located at sections of the mounting slots whereat the body portions are inserted.

8. The memory card connector of claim 7 wherein the body portions of the switch terminals are generally planar.

9. A memory card connector, comprising:
an insulative housing having a rear terminal-mounting section and at least one side wall section extending forwardly from one end of the rear section defining a card-receiving space therewith, the housing having at least a pair of switch terminal mounting slots in a surface of the housing, and a pair of recessed platforms in said surface on diametrically opposite sides of at least one of the narrow mounting slots; and
at least a pair of switch terminals insertable into the mounting slots in the housing, the switch terminals being stamped and formed of sheet metal material, with a portion of at least one switch terminal adjacent said recessed platforms being relatively thin and disposed in a relatively narrow section of the respective mounting slot,
whereby an appropriate insertion fixture can be provided with relatively wide terminal-engagement blocks aligned with said recessed platforms to fully insert the at least one switch terminal into the respective mounting slot.

10. The memory card connector of claim 9 wherein said mounting slots are in a surface of the side wall section of the housing.

11. The memory card connector of claim 10 wherein said mounting slots are in a top surface of the side wall section of the housing.

12. The memory card connector of claim 9 wherein aid switch terminals have body portions fixed in the mounting slots in the housing, contact spring arms cantilevered from the body portions and contact portions at free ends of the contact spring arms, said recessed platforms being located at sections of the mounting slots whereat the body portions are inserted.

13. A memory card connector, comprising:
an insulative housing having a terminal-mounting slot in a surface thereof, and a recessed platform in said surface adjacent the mounting slot; and
a terminal insertable into the mounting slot in the housing, whereby an appropriate insertion fixture can be provided with a relatively wide terminal-engagement block aligned with said recessed platform to fully insert the terminal into the mounting slot.

14. The memory card connector of claim 13 wherein a portion of said terminal adjacent said recessed platform is relatively thin and disposed in a relatively narrow section of the mounting slot.

15. The memory card connector of claim 14 wherein said terminal is stamped and formed of sheet metal material, and said portion of the terminal adjacent the recessed platform is only as thick as the sheet metal material of the terminal.

16. The memory card connector of claim 15, including a pair of said recessed platforms in said surface on diametrically opposite sides of the mounting slot.
